(19) United States
(12) Patent Application Publication
(10) Pub. No.: US 2020/0050413 A1
(43) Pub. Date: Feb. 13, 2020

(54) CONTROLLING PRINTING COPIES OF A PRINTABLE CONTENT

(71) Applicant: Hewlett-Packard Development Company, L.P., Spring, TX (US)

(72) Inventors: Jang Geun KIM, Seongnam-si (KR); Jin Myung JOO, Seongnam-si (KR); Sang Woo KIM, Seongnam-si (KR); Hyuk Jin GWON, Seongnam-si (KR)

(21) Appl. No.: 16/606,003

(22) PCT Filed: Jan. 15, 2018
(86) PCT No.: PCT/KR2018/000660

§ 371 Date: Oct. 17, 2019

(30) Foreign Application Priority Data
May 8, 2017 (KR) 10-2017-0057590

(51) Int. Cl. G06F 3/12

(52) U.S. Cl. CPC G06F 3/1275; G06F 3/1215; G06F 3/1274; G06F 3/1245; G06F 3/1286; G06F 3/122

(57) ABSTRACT

Provided are an image forming apparatus and a method of controlling collated printing in an image forming apparatus. For example, the image forming apparatus comprises an image former, a communicator to receive a print request from a host device; a controller to convert at least one portion of the data received from the host device into print data corresponding to one copy of the printable content by the image former, in response to the print request; and a memory to store the print data. The controller is to, in response to determining that the memory stores the print data, control the image former to print the plurality of copies of the printable content.

### TECHNICAL FIELD

Provided are an image forming apparatus and a method of controlling collated printing in an image forming apparatus.

### BACKGROUND ART

With the advancement of office automation equipment and in particular, an image forming apparatus such as a laser beam printer with a high printing speed, documents to be distributed to participants when a meeting, a lecture or a debate is conducted can be created. When the documents to be distributed are printed out using the laser beam printer with the high printing speed, the documents should be prepared in proportion to the number of the participants. As the number of participants increases, the amount of time needed to print out the documents increases.

When multiple copies of a multi-page document are printed using a collated printing function of an image forming apparatus, the multiple copies of the document are printed such that a copy of the document is printed from a first page to a last page and another copy of the document is printed from the first page to the last page.

### DISCLOSURE OF INVENTION

### Solution to Problem

Provided are an image forming apparatus and a method of controlling collated printing in an image forming apparatus. For example, the image forming apparatus comprises an image former, a communicator to receive a print request to print a plurality of copies of printed content comprising at least one page and data corresponding to the plurality of copies of the printable content from a host device; a controller to convert at least one portion of the data received from the host device into print data corresponding to one copy of the printable content to be printable by the image former, in response to the print request; and a memory to store the print data corresponding to the one copy of the printable content. The controller is to, in response to determining that the memory stores the print data corresponding to the one copy of the printable content, control the image former to print the plurality of copies of the printable content using the print data corresponding to the one copy of the printable content.

### BRIEF DESCRIPTION OF DRAWINGS

These and/or other aspects will become apparent and more readily appreciated from the following description of the examples, taken in conjunction with the accompanying drawings in which:

FIG. 1 is a block diagram of an image forming apparatus according to an example;

FIG. 2 is a diagram illustrating connection of an image forming apparatus to a host device or a server, according to an example;

FIG. 3 is a detailed block diagram illustrating a structure of an input and output unit according to an example;

FIG. 4 is a block diagram illustrating a basic structure of an image forming apparatus according to an example;

FIG. 5 is a flowchart of a method of controlling collated printing in an image forming apparatus, according to an example;

FIG. 6 is a diagram illustrating a process of controlling a print mode on the basis of a storage space of a memory, performed by an image forming apparatus, according to an example;

FIG. 7 is a flowchart of a process of transmitting and receiving data between a host device and an image forming apparatus by controlling collated printing, according to an example;

FIG. 8 is a flowchart of a process of performing a device print mode through a memory, performed by an image forming apparatus, according to an example;

FIG. 9 is a flowchart of a process of providing a finishing option when an image forming apparatus performs a device print mode, according to an example;

FIG. 10 is a diagram illustrating an input and output unit which provides a finishing option, according to an example;

FIG. 11 is a flowchart of a method of providing driver printing, performed by an image forming apparatus, according to an example;

FIG. 12 is a flowchart of a method of controlling collated printing, performed by an image forming apparatus, according to an example; and

FIG. 13 is a flowchart of a method of controlling collated printing on the basis of size information of one copy of print data for printable matter (or printable content), performed by an image forming apparatus, according to an example.

### BEST MODE FOR CARRYING OUT THE INVENTION

Provided are an image forming apparatus and a method of controlling collated printing in an image forming apparatus. For example, the image forming apparatus comprises an image former, a communicator to receive a print request to print a plurality of copies of printed content comprising at least one page and data corresponding to the plurality of copies of the printable content from a host device; a controller to convert at least one portion of the data received from the host device into print data corresponding to one copy of the printable content to be printable by the image former, in response to the print request; and a memory to store the print data corresponding to the one copy of the printable content. The controller is to, in response to determining that the memory stores the print data corresponding to the one copy of the printable content, control the image former to print the plurality of copies of the printable content using the print data corresponding to the one copy of the printable content.

### MODE FOR THE INVENTION

Reference will now be made in detail to examples, examples of which are illustrated in the accompanying drawings. In this regard, the examples may have different forms and should not be construed as being limited to the descriptions set forth herein. In order to further describe features of the examples, descriptions of other features that are known to one of ordinary skill in the art are omitted here.

In the specification, when an element is “connected” to another element, the elements may not only be “directly connected”, but may also be “electrically connected” via another element therebetween. Also, when a region “includes” an element, the region may further include another element instead of excluding the other element, unless otherwise differently stated.

As used herein, expressions such as “at least one of,” when preceding a list of elements, modify the entire list of elements and do not modify the individual elements of the list.

In the specification, an “image forming job” may denote any one of various jobs (for example, printing, copying, scanning, and faxing) related to an image, such as forming of an image or generating/storing/transmitting of an image file, and a “job” may denote not only an image forming job, but may also denote a series of processes required to perform the image forming job.

Also, an “image forming apparatus” may denote any apparatus capable of performing an image forming job, such as a printer, a scanner, a fax machine, a multi-function printer (MFP), or a display apparatus.

In the specification, in an example, an image forming apparatus may be understood as an image forming apparatus which does not include a large-capacity storage device such as a mass storage class (MSC) device. The MSC device is an auxiliary storage device configured to store a large amount of data and may be understood to mean a memory device capable of semi-permanently storing a large amount of data. Examples of the MSC may include a magnetic tape, a magnetic disk, a magnetic drum, a compact disc (CD)-read only memory (ROM), a hard disc, and a floppy disk.

A “host device” may be understood as a device capable of instructing an image forming apparatus to perform a printing job. Examples of the host device may include various types of electronic devices, such as a cellular phone, a tablet personal computer (PC), a digital camera, a camcorder, a laptop computer, a desktop computer, an e-book reader, a digital broadcast terminal, a personal digital assistant (PDA), a portable multimedia player (PMP), a navigation device, an MP3 player, a wearable device, etc.

In an example, a “memory” may be understood to mean a storage device used to store information such that an image forming apparatus can quickly use the information. In an example, a memory may be a volatile storage device from which data is removed when the supply of power to the image forming apparatus is stopped. For example, the memory may accumulatively store data needed to perform an operation of a controller in an image forming apparatus. The memory may be a volatile memory type. The memory may be a random access memory (RAM) and be used as a main memory device of a computer or used to temporarily load an application program or temporarily store data. Alternatively, the memory may be a dynamic random access memory (DRAM).

In an example, “driver printing” may be understood to mean that an image forming apparatus receives all pieces of print data regarding a plurality of copies of printable matter from a host device and prints the plurality of copies of the printable matter by using all the pieces of print data. For example, in driver printing, the image forming apparatus may print ten copies of twenty-page printable matter by receiving print data regarding 200 pages (20 pages×10 copies) from a host device.

In an example, “device printing” may be understood to mean that an image forming apparatus receives print data regarding one copy of printable matter from a host device and prints a plurality of copies of the printable matter using the print data regarding the one copy of the printable matter. For example, in device printing, the image forming apparatus may print ten copies of 20-page printable matter by receiving print data regarding 20 pages (20 pages×one copy) from the host device.

In an example, “one copy of printable matter” or “one copy of printable content” may be understood as printable matter or an printable content consisting of at least one page. When copies of content consisting of a plurality of pages are equally printed, “one copy of printable matter” or “one copy of printable content” may be understood as a copy of the content among the plurality of copies of the content.

Also, a “user” may denote a person who performs manipulation related to an image forming job by using an image forming apparatus or a device connected to the image forming apparatus wirelessly or via wires. Also, a “manager” may denote a person who has authority to access all functions and a system of an image forming apparatus. A “manager” and a “user” may be the same person.

Also, “content” may denote any type of data that is a target of an image forming job, such as a picture, an image, or a document file.

Examples set forth herein are related to an image forming apparatus capable of controlling collated printing and a method of controlling the image forming apparatus, and matters well known to those of ordinary skill in the art to which these examples pertain will not be described in detail below.

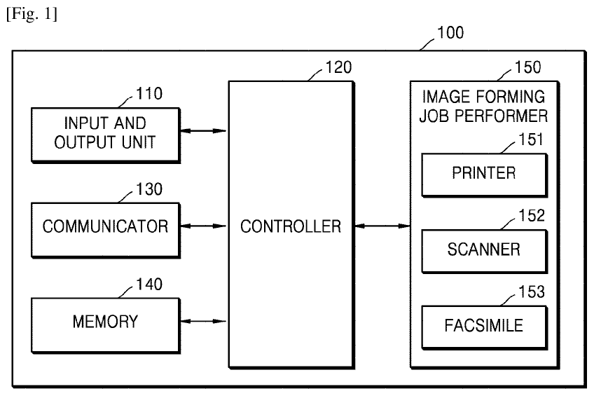

FIG. 1 is a block diagram of an image forming apparatus 100 according to an example. Referring to FIG. 1, the image forming apparatus 100 according to an example may include an input and output unit 110, a controller 120, a communicator 130, a memory 140, and an image forming job performer 150. Also, although not illustrated in FIG. 1, the image forming apparatus 100 may further include a power supplier for supplying power to each component of the image forming apparatus 100.

The input and output unit 110 may include an input unit for receiving, from a user, an input for performing an image forming job, and an output unit for displaying information, such as a result of performing an image forming job or a state of the image forming apparatus 100. For example, the input and output unit 110 may include an operation panel for receiving a user input and a display panel for displaying a screen.

In detail, the input unit may include at least one of devices for receiving various types of user inputs, such as a keyboard, a physical button, a touch screen, a camera, and a microphone. Also, the output unit may include, for example, a display panel or a speaker. However, an example is not limited thereto, and the input and output unit 110 may include at least one device supporting various inputs and outputs.

The controller 120 controls overall operations of the image forming apparatus 100, and may include a processor, such as a central processing unit (CPU). The controller 120 may control other components included in the image forming apparatus 100 such that an operation corresponding to a user input received through the input and output unit 110 is performed.

For example, the controller 120 may execute a program stored in the memory 140, read a file stored in the memory 140, or store a new file in the memory 140.

The communicator 130 may communicate with another device or a network in a wired or wireless manner. Accordingly, the communicator 130 may include a communication module supporting at least one of various wired and wireless communication methods. For example, the communication module may be in a form of a chipset or may be a sticker or a barcode (for example, a sticker including a near field communication (NFC) tag) including information required for communication.

Wireless communication may include, for example, at least one of wireless fidelity (Wi-Fi), Wi-Fi direct, Bluetooth, ultra wideband (UWB), and NFC. Wired communication may include, for example, at least one of universal serial bus (USB) and high definition multimedia interface (HDMI).

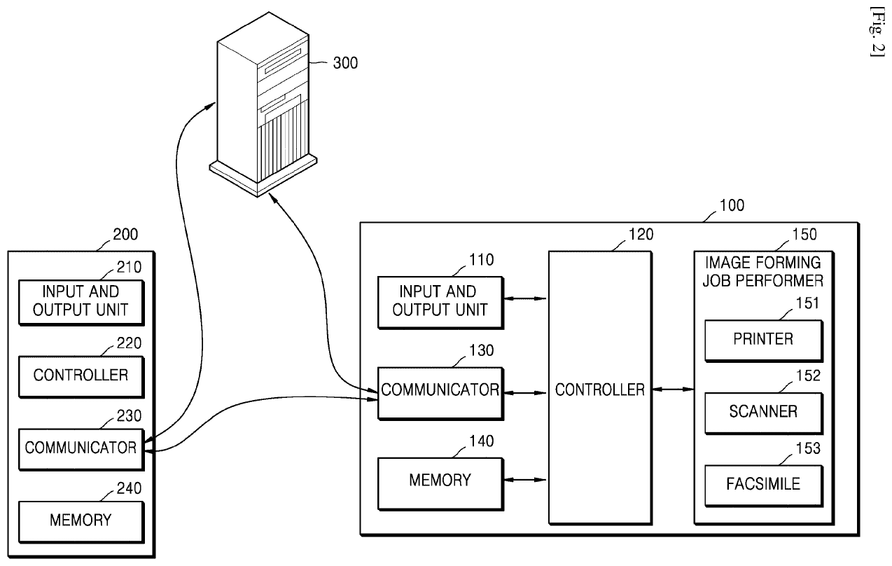

The communicator 130 may be connected to an external apparatus 200 provided outside the image forming apparatus 100 to transmit and receive a signal or data to and from the external apparatus 200. Referring to FIG. 2, the image forming apparatus 100 is connected to the external apparatus 200 or the server 300 through the communicator 130. The communicator 130 may transmit a signal or data received from the external apparatus 200 to the controller 120, or transmit a signal or data generated by the controller 120 to the external apparatus 200. For example, when the communicator 130 receives a print command signal or print data from the external apparatus 200, the controller 120 may output the print data through an image former 151, such as a printer 151.

As shown in FIG. 2, the external apparatus 200 may include an input and output unit 210, a controller 220, a communicator 230, and a memory 240.

The controller 220 may control an image forming job by executing a program stored in the memory 240 and transmitting a signal or data generated as a result of executing the program to the image forming apparatus 100 through the communicator 230.

Referring back to FIG. 1, the various types of data, such as a file or a program like an application, may be installed and stored in the memory 140. The controller 120 may access the data stored in the memory 140 to use the data, or may store new data in the memory 140. Also, the controller 120 may execute the program installed in the memory 140. Also, the controller 120 may install an application received from an external source through the communicator 130 in the memory 140.

The image forming job performer 150 may perform an image forming job, such as printing, scanning, or faxing.

Referring to FIG. 1, the image forming job performer 150 includes the printer 151, a scanner 152, and a facsimile 153, but as occasion demands, the image forming job 150 may include some of them or may further include a component for performing another type of image forming job.

The printer 151, may form an image on a recording medium via any one of various printing methods, such as an electrophotography method, an inkjet method, a thermal transfer method, and a thermal method.

The scanner 152 may irradiate light onto paper and receive light reflected from the paper to read an image recorded on the paper. Examples of an image sensor for reading an image from paper include a charge-coupled device (CCD) and a contact type image sensor (CIS). The scanner 152 may have a flatbed structure in which paper is located at a fixed location and an image sensor moves to read an image, a document feed structure in which an image sensor is located at a fixed location and paper is transferred, or a combination structure thereof.

The facsimile 153 may share a component for scanning an image with the scanner 152, share a component for printing a received file with the printer 151, transmit a scan file to a destination, or receive a file from an external source.

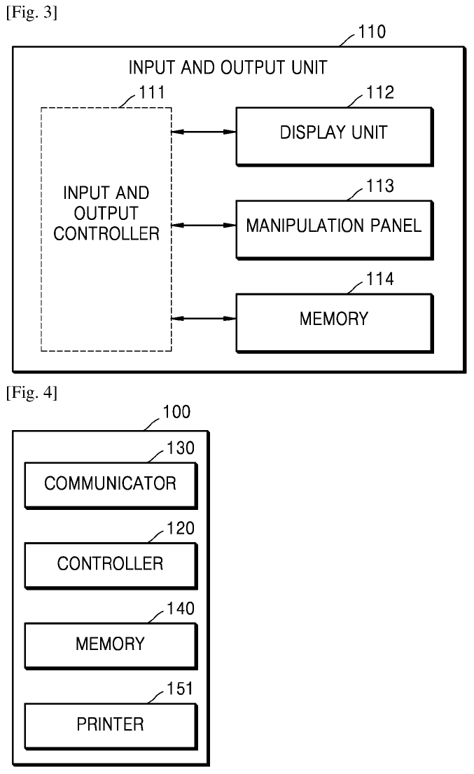

FIG. 3 is a detailed block diagram illustrating a structure of an input and output unit 110 according to an example. Referring to FIG. 3, the input and output unit 110 may include an input and output controller 111, a display unit 112, a user interface that may include a manipulation panel 113, and a memory 114.

As illustrated in FIG. 3, the input and output unit 110 may include a control system (the input and output controller 111 and the memory 114) independently from the controller 120. The input and output controller 111 and the memory 114 may control a user interface provided by the input and output unit 110. The input and output controller 111 may be embodied as a processor such as a CPU, similar to the controller 120. Alternatively, the input and output unit 110 may not include the input and output controller 111, and the controller 120 of the image forming apparatus 100 may function as the input and output controller 111.

The display unit 112 may be embodied as a liquid crystal display (LCD) panel, an organic light-emitting diode (OLED) panel, or the like. The manipulation panel 113 may be a physical button, a touch screen, or the like.

The input and output unit 110 may be separable from the image forming apparatus 100. For example, the input and output unit 110 may operate similarly to a tablet PC when it is separated from the image forming apparatus 100, and may perform an input/output function when it is coupled to the image forming apparatus 100. When the input and output unit 110 is separable from the image forming apparatus 100, the input and output unit 110 may further include a communicator to communicate with an external device.

The above-described examples may be embodied in the form of a non-transitory computer-readable recording medium configured to store instructions and data which are executable in a computer. At least one among the instructions and the data may be stored in the form of program code, and a program module may be generated to perform an operation when at least one among the instructions and the data is executed by a processor.

The non-transitory computer-readable recording medium may be understood, for example, as a magnetic recording medium such as a hard disc, an optical recording medium such as a compact disc (CD) or a digital versatile disc (DVD), or a memory included in a server which is accessible via a network.

Methods of controlling a collated print mode, performed by the image forming apparatus 100, according to examples will be described in below.

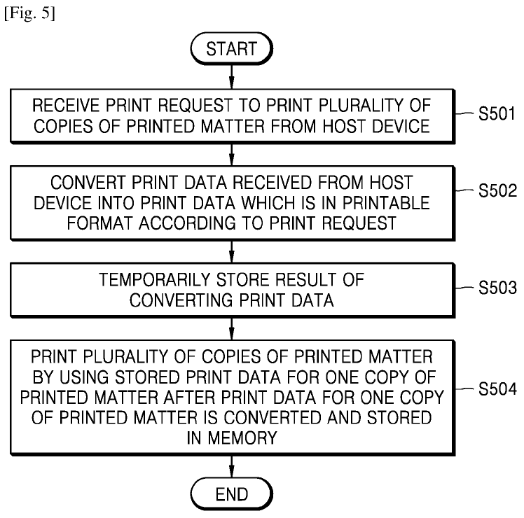

FIG. 4 is a block diagram illustrating a basic structure of an image forming apparatus 100 according to an example.

As illustrated in FIG. 4, the image forming apparatus 100 may include a communicator 130, a controller 120, a memory 140, and a printer 151.

In an example, the communicator 130 may receive a print request to print a plurality of copies of printable matter from the external device 200 of FIG. 2, e.g., a host device 200. The communicator 130 may receive print data regarding the plurality of copies of the printable matter from the host device 200. The communicator 130 may sequentially receive a plurality of pieces of print data from the host device 200. The communicator 130 may receive size information of one copy of printable matter from the host device 200.

Furthermore, the communicator 130 may transmit information regarding a printing state of the image forming apparatus 100 to the host device 200. The communicator 130 may transmit a signal requesting to stop transmission of print data to the host device 200.

In an example, a print request received from the host device 200 may include a collated printing command to print a plurality of copies of one printable matter.

In an example, the controller 120 may convert data or print data transmitted from the host device 200 into print data which is in a printable format (, for example, to be printable by an image forming apparatus), in response to the print request. In an example, the controller 120 may convert the print data into print data which is in the printable format as soon as the print data is received from the host device 200. The controller 120 may control the printer 151, to print the printable matter as soon as the print data is converted.

Furthermore, the controller 120 may determine whether print data for one copy of the printable matter (, for example, print data corresponding to one copy of the printable content (or the printable matter)). is stored in the memory 140. In an example, the controller 120 may check a storable space of the memory 140 in real time. In an example, the controller 120 may check the number of pages of print data stored in the memory 140 and a first page and a last page of the print data. In an example, the controller 120 may check a starting point and an ending point of the print data for one copy of the printable matter in real time.

In an example, the memory 140 may temporarily store a result of converting print data. In an example, the memory 140 may be a volatile memory which needs power to maintain a stored state of the result of converting the print data. In an example, the memory 140 may be a volatile memory in which the result of converting the print data stored therein is lost or deleted when the supply of power to the image forming apparatus 100 is stopped. For example, the memory 140 may be a RAM and may be used as a main memory device of a computer or used to temporarily load an application program or temporarily store data. Alternatively, the memory 140 may be a DRAM.

In an example, after print data for one copy of the printable matter is converted and stored in the memory 140, the image former 151, such as the printer 151, may print a plurality of copies of the printable matter by using the print data for the one copy of the printable matter. The image former 151, such as printer 151, may print a plurality of copies of the printable matter included in a print job command by using the print data stored in the memory 140.

In an example, the image former 151, such as printer 151, may perform printing a last page of one copy of the printable matter, by applying a finishing option after a last page of one copy of the printable matter is printed.

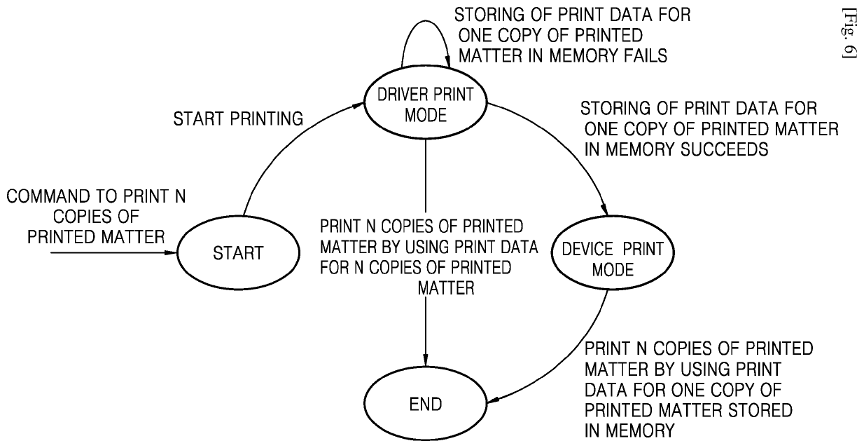

FIG. 5 is a flowchart of a method of controlling collated printing in an image forming apparatus, according to an example.

In an example, in operation S501, the image forming apparatus 100 may receive a print request to print a plurality of copies of printable matter from the host device 200. The image forming apparatus 100 may receive print data from the host device 200, based on the print request.

In an example, in operation S502, the image forming apparatus 100 may convert the print data received from the host device 200 into print data which is in a printable format according to the print request. The print data which is in the printable format may be understood as data converted into a format that can be printed by an image former, such as a printer. In one example, the image forming apparatus 100 may perform rasterizing or rendering on the print data received from the host device 200 to obtain print data that can be printed by an image former, such as a printer. In one example, the image forming apparatus 100 may convert the print data into a resolution appropriate for the image former 151, such as printer 151, of the image forming apparatus 100 or change the print data.

In an example, in operation S503, the image forming apparatus 100 may temporarily store a result of converting the print data. The image forming apparatus 100 may store the result of converting the print data in the memory 140 as soon as the conversion of the print data is completed. The image forming apparatus 100 may check a storable space of the memory 140 in real time while the print data is converted. In an example, the image forming apparatus 100 may check whether print data stored in the memory 140 is print data for one copy of the printable matter.

In an example, in operation S504, the image forming apparatus 100 may print a plurality of copies of the printable matter by using stored print data for one copy of the printable matter after the print data for the one copy of the printable matter is converted and stored in the memory 140. The image forming apparatus 100 may determine a print mode to be a device print mode when it is determined that the print data for the one copy of the printable matter is converted and stored in the memory 140.

In an example, one single copy of print data may be converted using the memory 140 which is a volatile memory of the image forming apparatus 100, and a plurality of copies of the printable matter may be printed using the converted copy of the print data, thereby increasing the speed of printing. Furthermore, in an example, device printing may be performed using a remaining storage space of the memory 140 which is a volatile memory of the image forming apparatus 100 and thus printing may be performed quickly without an additional large-capacity storage device.

FIG. 6 is a diagram illustrating a process of controlling a print mode on the basis of a storage space of the memory 140 of FIG. 1, performed by an image forming apparatus, according to an example. In one example, the process of controlling the print mode illustrated in FIG. 6 may be performed by the controller 120 of the image forming apparatus 100.

In an example, the image forming apparatus 100 may receive a print command to print N copies of printable matter from the host device 200. In one example, the image forming apparatus 100 may receive print data from the host device 200, together with the print command. In an example, the image forming apparatus 100 may convert the print data received from the host device 200 into print data which is a printable format. In one example, the image forming apparatus 100 may store the print data received from the host device 200 in the memory 140 while converting the print data into the print data which is in the printable format. In an example, the image forming apparatus 100 may start printing the printable matter by using the result of converting the print data.

In an example, the image forming apparatus 100 may determine a print mode to be a driver print mode as soon as the printing of the printable matter is started. In one example, the image forming apparatus 100 may check a storage space of the memory 140 while the printable matter is printed. In an example, the image forming apparatus 100 may check in real time whether print data regarding one copy of the printable matter may be stored in the memory 140. In an example, the image forming apparatus 100 may check a storage state of the memory 140 simultaneously with the printing of the printable matter.

In an example, when it is determined that the print data regarding the one copy of the printable matter is stored in the memory 140, the image forming apparatus 100 may be switched to the device print mode. In an example, the image forming apparatus 100 may inform the host device 200 of a state in which device printing may be performed through a network SNMP or USB auto-configuration. In an example, as the image forming apparatus 100 is switched to the device print mode, N copies of the printable matter may be printed using the print data regarding the one copy of the printable matter stored in the memory 140.

In an example, when it is determined that the print data regarding the one copy of the printable matter is not stored in the memory 140, the image forming apparatus 100 may be maintained to be in the driver print mode. The image forming apparatus 100 may receive all print data regarding N copies of the printable matter from the host device 200 and convert all the received print data into data which is printable. The image forming apparatus 100 may print N copies of the printable matter by using a result of converting all the print data.

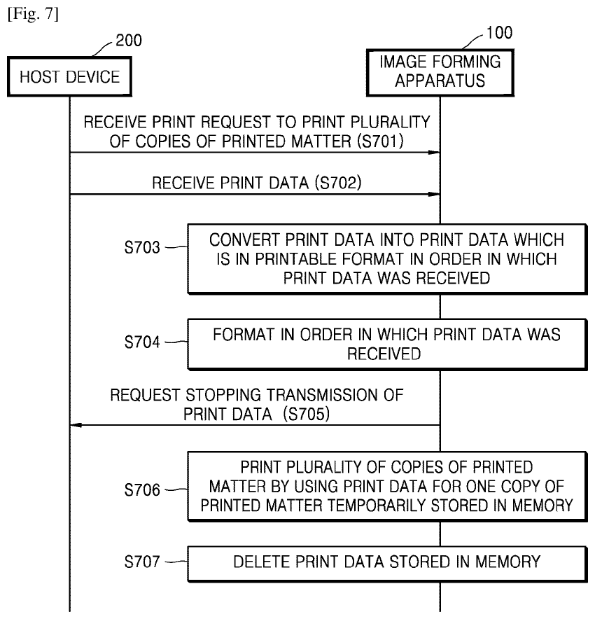

FIG. 7 is a flowchart of a process of transmitting and receiving data between a host device and an image forming apparatus by controlling collated printing, according to an example.

In an example, in operation S701, an image forming apparatus 100 may receive a print request to print a plurality of copies of printable matter from a host device 200. For example, the image forming apparatus 100 may receive a request to print ten copies of the printable matter from the host device 200.

In an example, in operation S702, the image forming apparatus 100 may sequentially receive pieces of print data for the plurality of copies of the printable matter from the host device 200.

In an example, in operation S703, the image forming apparatus 100 may convert the pieces of print data into print data which is in a printable format in an order in which the pieces of print data were received from the host device 200. For example, when one copy of printable matter consists of twenty pages, the image forming apparatus 100 may receive print data corresponding to each of the 20 pages, and convert the print data into print data which is in the printable format as soon as the print data was received.

In an example, in operation S704, the image forming apparatus 100 may complete temporarily storing print data for one copy of the printable matter. The image forming apparatus 100 may check pages of the print data of the one copy of the printable matter while storing a result of converting the print data in the memory 140. In one example, when a last page among at least one page constituting one copy of the printable matter is stored in the memory 140, the image forming apparatus 100 may determine that storing of the print data regarding the one copy of the printable matter is completed. For example, when print data regarding 1 to 20 pages is stored in the memory 140, the image forming apparatus 100 may determine that storing of the print data for one copy of the printable matter is completed.

In an example, in operation S705, the image forming apparatus 100 may request the host device 200 to stop transmission of the print data. The image forming apparatus 100 does not receive print data for a plurality of copies of the printable matter from the host device 200 any longer.

In an example, in operation S706, the image forming apparatus 100 may print a plurality of copies of the printable matter by using the print data for the one copy of the printable matter which is temporarily stored in the memory 140. For example, the image forming apparatus 100 may print ten copies of the printable matter by using twenty-page print data stored in the memory 140.

In an example, in operation S707, the image forming apparatus 100 may delete the print data stored in the memory 140 after the printing of the plurality of copies of the printable matter is completed. The image forming apparatus 100 may delete the print data stored in the memory 140 to secure a storage space of the memory 140 after the printing of the plurality of copies of the printable matter is completed.

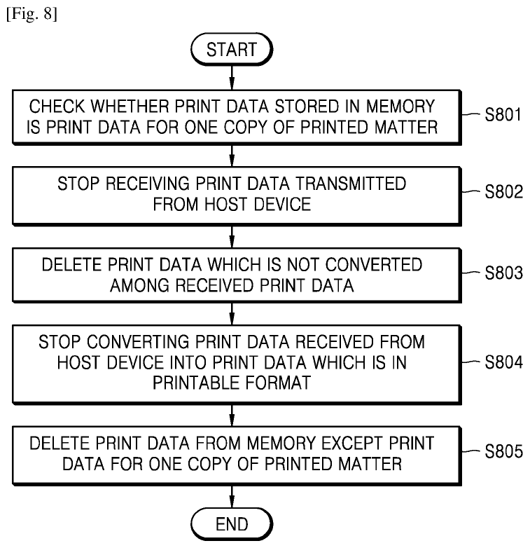

FIG. 8 is a flowchart of a process of performing the device print mode through the memory 140 of FIG. 1, performed by the image forming apparatus 100 of FIG. 1, according to an example.

In an example, in operation S801, the image forming apparatus 100 may check whether print data stored in the memory 140 is print data for one copy of a printable matter. For example, the image forming apparatus 100 may determine whether a last page of the print data for the one copy of the printable matter is stored in the memory 140.

In an example, in operation S802, the image forming apparatus 100 may stop receiving print data transmitted from the host device 200.

In an example, in operation S803, the image forming apparatus 100 may delete print data which is not converted in a printable format among the print data received from the host device 200.

In an example, in operation S804, the image forming apparatus 100 may stop converting the print data received from the host device 200 into print data which is in the printable format.

In an example, in operation S805, the image forming apparatus 100 may delete the print data from the memory 140 except the print data for the one copy of the printable matter. The image forming apparatus 100 may secure an additional storage space of the memory 140 by deleting the print data except print data needed for printing.

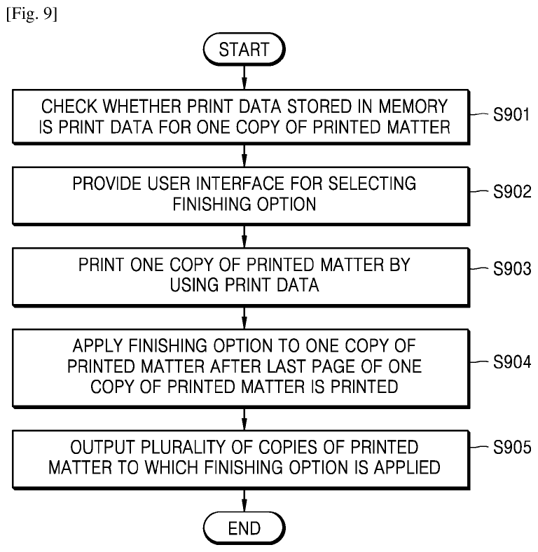

FIG. 9 is a flowchart of a process of providing a finishing option when an image forming apparatus performs the device print mode, according to an example.

In an example, a starting point and an ending point of one copy of printable matter are clearly determined when the image forming apparatus 100 performs printing in the device print mode. Thus, a plurality of copies of the printable matter may be printed in a collated manner. Accordingly, when the image forming apparatus 100 performs printing in the device print mode, the finishing option may be provided for each of a plurality of copies of the printable matter to be printed.

Here, the finishing option may include stapling, arranging, punching, or the like. In one example, the finishing option is not limited thereto and may vary according to a function provided by the image forming apparatus 100.

In an example, in operation S901, the image forming apparatus 100 may check whether print data stored in the memory 140 is print data for one copy of printable matter. When it is determined that the print data for the one copy of the printable matter is stored in the memory 140, the image forming apparatus 100 may perform printing in the device print mode.

In an example, in operation S902, the image forming apparatus 100 may provide a user interface for selecting the finishing option. The image forming apparatus 100 may provide the user interface through the input and output unit 110. In one example, in the image forming apparatus 100, the finishing option may be selected through the user interface by a user. For example, in the image forming apparatus 100, staple finishing may be selected by a user.

In an example, in operation S903, the image forming apparatus 100 may print one copy of the printable matter by using the print data stored in the memory 140.

In an example, in operation S904, the image forming apparatus 100 may apply the finishing option to one copy of the printable matter after a last page of the one copy of the printable matter is printed. For example, the image forming apparatus 100 may apply stapling to one copy of the printed matter and output the one copy of the printed matter after the last page of one copy of the printed matter is printed.

In an example, in operation S905, the image forming apparatus 100 may output a plurality of copies of the printed matter to which the finishing option is applied. For example, the image forming apparatus 100 may output a plurality of copies of the printed matter to which stapling is applied.

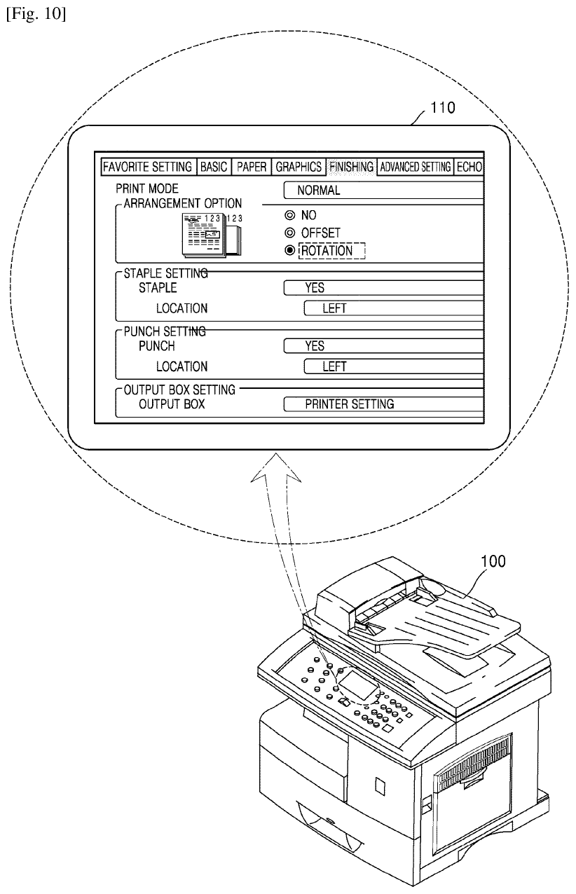

FIG. 10 is a diagram illustrating an input and output unit which provides a finishing option, according to an example.

In an example, the image forming apparatus 100 may provide a user interface for selecting the finishing option through the input and output unit 110. When a plurality of copies of multiple-page printable matter are printed, the finishing option is an option applied to separate the plurality of copies of the printed matter from one another.

In an example, the image forming apparatus 100 may provide arranging, punching, stapling, bookbinding, double-sided printing, etc. as the finishing option. In one example, the finishing option provided by the image forming apparatus 100 may vary according to a function of the image forming apparatus 100 but is not limited thereto.

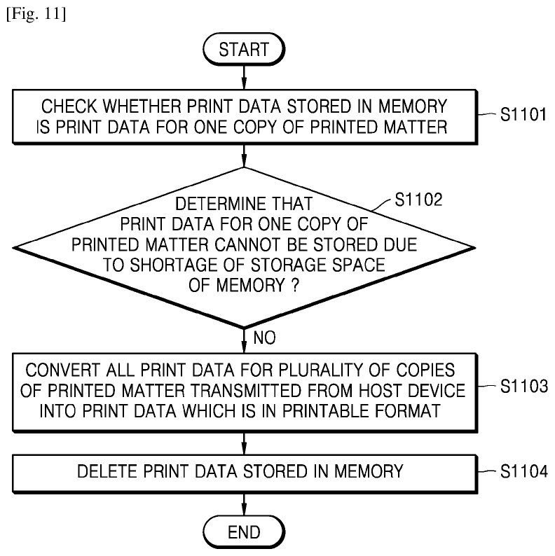

FIG. 11 is a flowchart of a method of providing driver printing, performed by an image forming apparatus, according to an example

In an example, in operation S1101, the image forming apparatus 100 may check whether print data stored in the memory 140 is print data for one copy of a printable matter. The image forming apparatus 100 may check a remaining storage space of the memory 140 in real time.

In an example, in operation S1102, the image forming apparatus 100 may determine that print data for one copy of the printable matter cannot be stored due to a shortage of a storage space of the memory 140. For example, the image forming apparatus 100 may determine that device printing cannot be performed when ten pages of twenty-page print data are stored in the memory 140.

In an example, in operation S1103, the image forming apparatus 100 may convert all print data for a plurality of copies of a printable matter which is transmitted from a host device into print data which is in a printable format. In one example, the image forming apparatus 100 may perform printing in a drive print mode.

In an example, in operation S1104, the image forming apparatus 100 may delete the print data stored in the memory 140. In one example, the image forming apparatus 100 does not use the print data stored in the memory 140 for printing and thus all the print data stored in the memory 140 may be deleted.

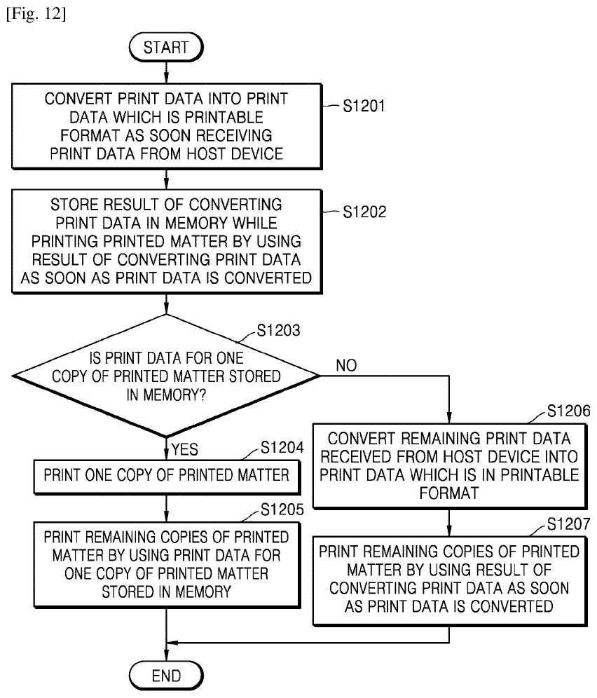

FIG. 12 is a flowchart of a method of controlling collated printing, performed by an image forming apparatus, according to an example. As illustrated in FIG. 12, the image forming apparatus 100 of FIG. 1 may be switched to the device print mode while performing printing in the driver print mode. Alternatively, the image forming apparatus 100 may be switched to the driver print mode while performing printing in the device print mode. Thus, the image forming apparatus 100 may perform print mode switching by using a RAM which is a volatile memory without causing an error to occur.

In an example, in operation S1201, as soon receiving print data from the host device 200, the image forming apparatus 100 may convert the print data into print data which is a printable format. For example, the image forming apparatus 100 may receive print data for a twenty-page printable matter in units of pages, and convert the print data into print data which is in the printable format in an order in which the pages were received.

In an example, in operation S1202, the image forming apparatus 100 may print the printable matter by using a result of converting the print data as soon as the print data is converted, and store the result of converting the print data in the memory 140. For example, the image forming apparatus 100 may print a result of converting a first page of print data for one copy of a printable matter as soon as converting the first page of the print data for the one copy of the printable matter, and store print data for the result of converting the first page in the memory 140.

In an example, in operation S1203, the image forming apparatus 100 may check whether the print data for the one copy of the printable matter is stored in the memory 140. For example, the image forming apparatus 100 may check whether the print data stored in the memory 140 includes all pages for one copy of the printable matter.

In an example, in operation S1204, the image forming apparatus 100 may perform printing in the device print mode when the print data for the one copy of the printable matter is stored in the memory 140. For example, the image forming apparatus 100 may complete printing one copy of the printable matter. Furthermore, the image forming apparatus 100 may stop receiving print data from the host device 200. For example, in order to print ten copies of a twenty-page printable matter, the image forming apparatus 100 may receive twenty-page print data for one single copy of the printable matter.

In an example, in operation S1205, the image forming apparatus 100 may print remaining copies of the printable matter using the print data for one copy of the printable matter stored in the memory 140. For example, the image forming apparatus 100 may print ten copies of a 20-page printable matter by using twenty-page print data.

In an example, in operation S1206, when the print data for one copy of the printable matter is not stored in the memory 140, the image forming apparatus 100 may perform printing in the driver print mode. In an example, the image forming apparatus 100 may convert remaining print data received from the host device 200 into print data which is in a printable format. In this case, the print data received from the host device 200 by the image forming apparatus 100 may be understood as all print data for a plurality of copies of the printable matter. For example, the image forming apparatus 100 may receive print data corresponding to 200 pages to print ten copies of a twenty-page printable matter.

In an example, in operation S1207, the image forming apparatus 100 may print remaining copies of the printable matter by using a result of converting the print data as soon as the print data is converted. For example, the image forming apparatus 100 may print a printable matter consisting of a total of 200 pages by using 200-page print data.

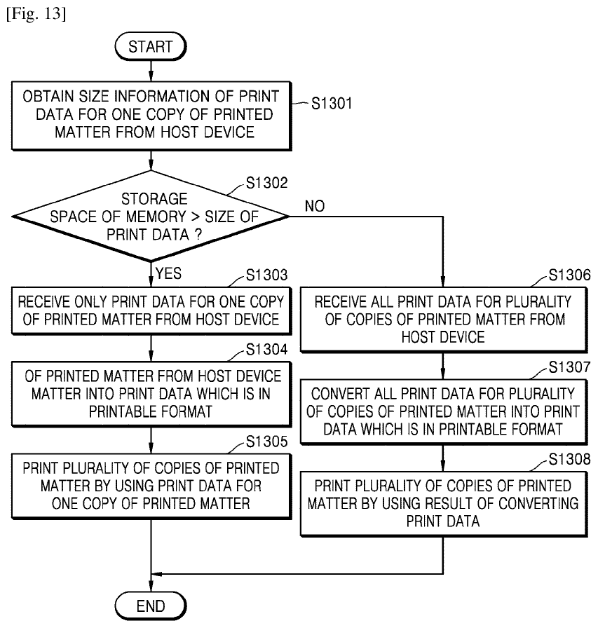

FIG. 13 is a flowchart of a method of controlling collated printing on the basis of size information of print data for one copy of a printable matter, performed by an image forming apparatus, according to an example.

In an example, in operation S1301, the image forming apparatus 100 may obtain size information of print data for one copy of a printable matter from the host device 200. In one example, the image forming apparatus 100 may obtain the size information of the print data when the print data is converted into a printable format.

In an example, in operation S1302, the image forming apparatus 100 may compare a storage space of the memory 140 with a size of the print data. In one example, the memory 140 included in the image forming apparatus 100 may be a volatile memory.

In an example, in operation S1303, the image forming apparatus 100 may perform printing in the device print mode when the storage space of the memory 140 is greater than the size of the print data. For example, the image forming apparatus 100 may receive the print data for one single copy of the printable matter from the host device 200.

In an example, when the host device 200 is a mobile device, data for transmitting the print data may be saved.

In an example, in operation S1304, the image forming apparatus 100 may convert the print data for one single copy of the printable matter into print data which is in a printable format.

In an example, in operation S1305, the image forming apparatus 100 may print a plurality of copies of the printable matter by using the print data for the one copy of the printable matter.

In an example, in operation S1306, when the storage space of the memory 140 is less than the size of the print data, the image forming apparatus 100 may perform printing in the driver print mode.

In an example, in operation S1307, the image forming apparatus 100 may convert all print data for a plurality of copies of the printable matter into print data which is in the printable format.

In an example, in operation S1308, the image forming apparatus 100 may print a plurality of copies of the printable matter by using a result of converting the print data.

In an example, as illustrated in FIG. 13, the image forming apparatus 100 may quickly determine the device print mode or the driver print mode by obtaining size information of data regarding one copy of the printable matter beforehand from the host device 200. When printing is performed in the device print mode, the image forming apparatus 100 need not receive the print data except the print data for one copy of the printable matter and thus effects such as reducing use of data, increasing a printing speed, reducing an error caused when print modes are switched, etc. may be obtained.

While examples have been particularly shown and described, it will be understood by those of ordinary skill in the art that various changes in form and details may be made therein without departing from the spirit and scope of the inventive concept as defined by the appended claims. Thus the examples should be considered in descriptive sense only and not for purposes of limitation. Therefore, the scope of the inventive concept is defined not by the detailed description thereof but by the appended claims, and all differences within the scope will be construed as being included in the inventive concept.

The above-described examples can be embodied as a computer program and realized in a general-purpose digital computer via a computer-readable recording medium. Examples of the computer-readable recording medium include a magnetic recording medium (a ROM, a floppy disk, a hard disc, etc.) and an optical recording medium (a CD-ROM, a DVD, etc.).

1. An image forming apparatus comprising:
an image former;
a communicator to receive a print request to print a plurality of copies of a printable content comprising at least one page and data corresponding to the plurality of copies of the printable content from a host device;
a controller to convert at least one portion of the data received from the host device into print data corresponding to one copy of the printable content to be printable by the image former, in response to the print request; and
a memory to store the print data corresponding to the one copy of the printable content,
wherein, the controller is to, in response to determining that the memory stores the print data corresponding to the one copy of the printable content, control the image former to print the plurality of copies of the printable content using the print data corresponding to the one copy of the printable content.

2. The image forming apparatus of claim 1, wherein, for the determining that the memory stores the print data corresponding to the one copy of the printable content, the controller is to determine whether the memory stores the print data corresponding to the one copy of the printable content.

3. The image forming apparatus of claim 2, wherein the memory is a volatile memory from which the stored print data is lost when a supply of power to the image forming apparatus is stopped.

4. The image forming apparatus of claim 2, wherein, in response to the determining that the memory stores the print data corresponding to the one copy of the printable content, the controller is to control the communicator to stop receiving the data from the host device.

5. The image forming apparatus of claim 2, wherein, in response to the determining that the memory stores the print data corresponding to the one copy of the printable content, the controller is to delete an unconverted portion of the data received from the host device.

6. The image forming apparatus of claim 2, wherein, in response to the determining that the memory stores the print data corresponding to the one copy of the printable content, the controller is to stop converting an unconverted portion of the data received from the host device.

7. The image forming apparatus of claim 2, wherein, in response to the determining that the memory stores the print data corresponding to the one copy of the printable content, the controller is to delete stored print data stored in the memory other than the print data corresponding to the one copy of the printable content.

8. The image forming apparatus of claim 2, wherein, in response to the determining that the memory stores the print data corresponding to the one copy of the printable content, the controller is to provide at least one finishing option via a user interface for selecting a finishing option among the at least one finishing option.

9. The image forming apparatus of claim 8, wherein, after the one copy of the printable content is printed to be a copy of a printed content, the printer is to apply the finishing option selected through the user interface to the copy of the printed content and output the copy of the printed content to which the finishing option is applied.

10. The image forming apparatus of claim 1, wherein, when the memory is unable to store the print data corresponding to the one copy of the printable content due to a shortage of storage space of the memory, the controller is to convert all of the data corresponding to the plurality of copies of the printable content received from the host device into print data in the printable format.

11. The image forming apparatus of claim 10, wherein, when the memory is unable to store the print data corresponding to the one copy of the printable content, the controller is to delete the print data stored in the memory.

12. The image forming apparatus of claim 2, wherein the controller is to, while converting the at least one portion of the data received from the host device into the print data corresponding to the one copy of the printable content to be printable by the image former,
control the image former to print the one copy of the printable content by using the print data corresponding to the one copy of the printable content being converted, and
check whether the memory is capable of storing the print data corresponding to the one copy of the printable content.

13. The image forming apparatus of claim 1, wherein the controller is to obtain size information of the print data corresponding to the one copy of the printed content from the host device, and determine that the print data corresponding to the one copy of the printed content is to be stored in the memory, based on the size information of the print data corresponding to the one copy of the printed matter.

14. A method of controlling collated printing in an image forming apparatus, the method comprising:
receiving a print request to print a plurality of copies of printable content comprising at least one page and data corresponding to the plurality of copies of the printable content from a host device;
converting at least one portion of the data received from the host device into print data corresponding to one copy of the printable content to be printable by a image former of the image forming apparatus, in response to the print request;
storing the print data corresponding to the one copy of the printable content in a memory; and
in response to determining that the memory stores the print data corresponding to the one copy of the printable content, controlling the image former to print the plurality of copies of the printable content using the print data corresponding to the one copy of the printable content.

15. A non-transitory computer-readable recording medium having recorded thereon a computer-executable program for executing the method of claim 14.
